(19) United States
(12) Patent Application Publication
(10) Pub. No.: US 2026/0258293 A1
(43) Pub. Date: Sep. 3, 2026

(54) GEOPOLYMER CEMENTING COMPOSITION

(71) Applicant: King Fahd University of Petroleum and Minerals, Dhahran (SA)

(72) Inventors: Salaheldin Mahmoud Ahmed ELKATATNY, Dhahran (SA); Ahmed Elsayed Ahmed Ibrahim ABDELAAL, Dhahran (SA)

(73) Assignee: King Fahd University of Petroleum and Minerals, Dhahran (SA)

(21) Appl. No.: 19/279,147

(22) Filed: Jul. 24, 2025

Related U.S. Application Data
(60) Provisional application No. 63/765,358, filed on Feb. 28, 2025.

(51) Int. Cl. C09K 8/467; C04B 14/10; C04B 14/30; C04B 18/08; C04B 22/06; C04B 28/00; C04B 103/20; C04B 103/32; C04B 103/50; E21B 33/13

(52) U.S. Cl. CPC C09K 8/467; C04B 14/10; C04B 14/308; C04B 18/08; C04B 22/062; C04B 28/006; E21B 33/13; C04B 2103/20; C04B 2103/32; C04B 2103/50; C04B 2201/10; C04B 2201/20; C04B 2201/50

(57) ABSTRACT

A method of downhole cementing using a geopolymer cementing composition which includes class F fly ash particles including 50 weight percentage (wt. %) to 62.5 wt. % SiO₂, 25 to 35 wt. % Al₂O₃, 2.5 to 7.5 wt. % CaO, 2.5 to 7.5 wt. % Fe₂O₃, 0.5 to 3.5 wt. % TiO₂, and 0.5 to 3.5 wt. % K₂O, hematite particles and laponite particles. The laponite particles include 52.5 to 65 wt. % SiO₂, 20 to 35 wt. % MgO, 1 to 4 wt. % Na₂O, and 0.1 to 1.5 wt. % Li₂O. The composition also includes a binder including an aqueous alkaline solution containing 1 to 8 mol/L an alkali activator which is KOH, NaOH, and/or Na₂SiO₃. Once cured, the bottom third of the cured specimen has a density of X and a porosity of Y and the top third of the cured cement has a density of 0.75*X to 1.05*X and a porosity of 0.60*Y to 1.10*Y.

### CROSS REFERENCE TO RELATED APPLICATIONS

This application is claims priority to U.S. Provisional Application No. 63/765,358, filed on Feb. 28, 2025. The entire contents of the above-identified applications are incorporated herein by reference.

### STATEMENT REGARDING PRIOR DISCLOSURE BY THE INVENTORS

Aspects of the present invention are described in Abdelaal et al., “Revolutionizing High-Pressure Well Cementing: Enhancing Geopolymer Cement with Laponite for Sustainable and Sedimentation-Free Applications” published in Volume 30, Issue 03, 2025, SPE Journal, which is incorporated herein by reference in its entirety.

### BACKGROUND

### Technical Field

The present disclosure relates to cementing compositions for use in subterranean well operations. More particularly, the present disclosure pertains to geopolymer cementing compositions formulated with an alkaline binder system, suitable for high-pressure oil and gas well cementing applications.

### Description of Related Art

The “background” description provided herein is for the purpose of generally presenting the context of the disclosure. The work of the presently named inventors, to the extent it is described in this background section, as well as aspects of the description which may not otherwise qualify as prior art at the time of filing, are neither expressly nor impliedly admitted as prior art against the present invention.

Ordinary Portland cement (OPC) is widely used in well cementing operations. However, OPC encounters several technical and environmental challenges. However, OPC encounters several technical and environmental challenges. The technical and environmental challenges associated with OPC include gas invasion, instability under high temperature and corrosive conditions, mechanical failure, and strength retrogression at elevated temperatures. Further, OPC systems are prone to acid attacks and show a marked reduction in compressive strength upon contact with drilling mud, which adversely impacts rheological behaviour and pumpability of Ordinary Portland cement systems. Additionally, production of OPC results in substantial greenhouse gas emissions and high energy consumption.

In order to address the technical and environmental challenges of OPC and promote sustainable alternatives, researchers explore a variety of supplementary materials to modify or replace OPC. Among the supplementary materials for cement replacement, geopolymers have gained increasing attention. Geopolymer technology, primarily developed for construction applications, is being evaluated for suitability in oil well cementing. Geopolymers are synthesized through the alkali activation of aluminosilicate materials, resulting in a hardened matrix with low permeability and favourable mechanical properties. Geopolymer binders are environmentally favourable because alkali-activated aluminosilicate materials require less energy to produce and utilize industrial or agricultural by-products such as fly ash, slag, and rice husk ash, thereby lowering CO₂ emissions.

Class F fly ash, derived from the combustion of bituminous coal, is a low-calcium by-product that has been widely used in geopolymer synthesis due to the high content of amorphous silica and alumina in Class F fly ash. Compared to OPC, fly ash-based geopolymers provide improved performance, including better chemical resistance, thermal stability, long-term durability, and tolerance to drilling mud contamination.

In deep or high-pressure wells, cement slurry formulations must accommodate elevated density requirements, often exceeding 17 pounds per gallon (ppg). One conventional method to increase cement slurry density involves reducing the water-to-solid ratio. However, lowering water content in cement slurry often leads to reduced pumpability, accelerated setting time, and the need for higher pumping pressures. Reduced pumpability, accelerated setting time, and higher pumping pressures may hinder proper placement of the cement slurry. To achieve the desired slurry density without compromising pumpability, weighting materials such as hematite are frequently added to the cement slurry.

Weighting agents are extensively used in drilling fluids, but incorporation of weighting agents into geopolymer cement systems remains relatively underexplored. Most studies involving weighting agents in geopolymers focus on barite-based formulations, with limited investigations on hematite-containing geopolymer systems. Hematite-based geopolymer systems tend to exhibit low thickening times and are prone to sedimentation due to the large particle size of hematite as the weighting material. Sedimentation during placement of hematite-based geopolymer slurries leads to an uneven distribution of solids, causing vertical density gradients and irregular compressive strength development along the cement column. Non-uniformity in the cement column compromises zonal isolation and long-term structural integrity of the cemented wellbore [B. Nelson, et al., Well cementing., Schlumberger, 2006, incorporated herein by reference in its entirety].

Recent literature has proposed various chemical additives to improve the pumpability of hematite-containing geopolymer slurries. However, recent literature often omit comprehensive evaluations of sedimentation behaviour in hematite-based geopolymer systems. Sedimentation continues to pose a challenge in heavy weight geopolymer systems, particularly when high-density additives are incorporated into the geopolymer formulations [A. Malyshev, et al. SPE AEE 2013. 1, 627, incorporated herein by reference in its entirety].

Laponite is a synthetic clay mineral composed of lithium sodium magnesium silicate.

Due to the unique disc-like morphology and surface charge characteristics of laponite, laponite is widely used as a rheological modifier and reinforcing agent in multiple industries including mining, petroleum, pharmaceuticals, agrochemicals, and paint polymers, anti-sagging of barite in drilling muds, and plugging and lubrication in water-based drilling fluids. In the dry state, the electron-rich faces of laponite particles share electrons with sodium atoms located in the interlayer space of the laponite structure. When dispersed in an aqueous medium, sodium ions dissociate from the laponite surface, imparting a permanent negative charge to the particle faces of laponite.

Existing studies on laponite usage in oilfield applications demonstrate improvements in drilling fluid performance, creating motivation to explore the feasibility of incorporating laponite into high-density fly ash-based geopolymer cement systems. Accordingly, one object of the present disclosure is to provide a geopolymer cementing composition and a method of downhole cementing, that may circumvent the above specified drawbacks and limitation of the materials and methods known in the art.

### SUMMARY

In an exemplary embodiment, a geopolymer cementing composition is described. The composition includes class F fly ash particles including 50 weight percentage (wt. %) to 62.5 wt. % SiO₂, 25 to 35 wt. % Al₂O₃, 2.5 to 7.5 wt. % CaO, 2.5 to 7.5 wt. % Fe₂O₃, 0.5 to 3.5 wt. % TiO₂, and 0.5 to 3.5 wt. % K₂O, hematite particles and laponite particles. The laponite particles include 52.5 to 65 wt. % SiO₂, 20 to 35 wt. % MgO, 1 to 4 wt. % Na₂O, and 0.1 to 1.5 wt. % Li₂O.

The composition further includes a binder including an aqueous alkaline solution further including 1 to 8 mol/L an alkali activator which is at least one selected from the group consisting of KOH, NaOH, and Na₂SiO₃, where the geopolymer cementing composition has a specific gravity of 15 to 20 ppg.

In some embodiments, the class F fly ash particles have a mean particle size of 5 micrometers (μm) to 50 μm.

In some embodiments, the class F fly ash particles further include 0.1 to 1.0 wt. % SO₃.

In some embodiments, the hematite particles have a mean particle size of 5 to 50 μm.

In some embodiments, the laponite particles have a mean particle size of 1 to 25 μm.

In some embodiments, the alkali activator is NaOH.

In some embodiments, the laponite particles are present in an amount of 1 to 10% of the weight of the binder. In some embodiments, the hematite particles are present in an amount of 50 to 100% of the weight of the binder In some embodiments, the composition further includes one or more superplasticizers (SPs) in an amount of 2.5 to 10% of the weight of the binder, one or more retarders in an amount of 2.5 to 10% of the weight of the binder, and a defoamer in an amount of 0.01 to 0.02% of the weight of the binder.

In some embodiments, the composition has a 10 min gel strength of 400 to 650 lbf/100 ft² at 82° F., and a 10 min gel strength of 75 to 200 lbf/100 ft² at 195° F.

In some embodiments, the composition has a plastic viscosity of 750 to 1250 cP at 82° F.; and a plastic viscosity of 250 to 500 cP at 195° F.

In some embodiments, the composition has a yield point of 10 to 16.5 lbf/100 ft² at 82° F.; and a yield point of 7.5 to 13.5 lbf/100 ft² at 195° F.

In some embodiments, the composition is substantially free of an Ordinary Portland Cement.

In another exemplary embodiment, method of producing a cured specimen is described.

The method includes mixing and casting the geopolymer cementing composition to form a cast composition, and curing the cast composition for 12 to 48 hours thereby forming the cured specimen.

In some embodiments, the curing is conducted at a temperature of 225 to 375° F.

In some embodiments, the cured specimen has a 24-hr unconfined compressive strength of 2000 to 3000 psi.

In some embodiments, the cured specimen has a Young's modulus of 3.5 to 9 GPa.

In some embodiments, the cured specimen has a density of 1.75 to 2.25 g/cm³.

In some embodiments, the bottom third of the cured specimen has a density of X and the top third of the cured cement has a density of 0.75*X to 1.05*X.

In some embodiments, the bottom third of the cured specimen has a porosity of Y and the top third of the cured cement has a porosity of 0.60*Y to 1.10*Y.

In some embodiments, the acid is sulfamic acid.

In yet another exemplary embodiment, a method of downhole cementing is described. The method includes injecting into a borehole the geopolymer cementing composition, and curing the geopolymer cementing composition, where the injecting is performed at a borehole temperature of greater than 150° F., and the geopolymer cementing composition is substantially free of an Ordinary Portland Cement.

In some embodiments, the method of cementing is conducted in at least one of an oil well and a gas well having a temperature of 150 to 400° F.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates an exemplary flow chart depicting a method of producing a cured specimen, according to certain embodiments.

FIG. 1B illustrates an exemplary flow chart depicting a method of downhole cementing, according to certain embodiments.

FIG. 2 illustrates a particle size distribution (PSD) curve of Class F fly ash (FFA), hematite, and laponite, according to certain embodiments.

FIG. 3A illustrates a scanning electron microscopy (SEM) image of Class F fly ash particles showing spherical morphology, according to certain embodiments.

FIG. 3B illustrates a SEM of hematite particles showing irregular morphology, according to certain embodiments.

FIG. 3C illustrates a SEM image of laponite particles showing disk-like morphology, according to certain embodiments.

FIG. 4 provides an overview of the experimental methods and workflow followed for the preparation, characterization, and evaluation of geopolymer cementing compositions, according to certain embodiments.

FIG. 5 illustrates an optical image of cured geopolymer samples prepared using different concentrations of laponite, according to certain embodiments.

FIG. 6 illustrates a graph summarizing the API method results showing density variations across the top, middle, and bottom sections of samples prepared with varying laponite concentrations, according to certain embodiments.

FIG. 7 illustrates a graph showing the NMR-derived porosity values for different laponite concentrations, according to certain embodiments.

FIG. 8A illustrates the NMR porosity distribution among the top, middle, and bottom sections of a geopolymer sample prepared without laponite, according to certain embodiments.

FIG. 8B illustrates the NMR porosity distribution among the top, middle, and bottom sections of a geopolymer sample prepared with 3 wt. % laponite, according to certain embodiments.

FIG. 9 illustrates a graph comparing density differences and NMR porosity differences between the top and bottom sections of geopolymer samples with varying laponite concentrations, according to certain embodiments.

FIG. 10A illustrates CT-scan imaging of a geopolymer sample prepared without laponite, showing density variation across horizontal slices, according to certain embodiments.

FIG. 10B illustrates CT-scan imaging of a geopolymer sample containing 1.5 wt. % laponite, showing intermediate density variation, according to certain embodiments.

FIG. 10C illustrates CT-scan imaging of a geopolymer sample containing 3 wt. % laponite, showing minimal density variation and uniform color distribution, according to certain embodiments.

FIG. 11 illustrates a graph showing the effect of laponite concentration on the 24-hour unconfined compressive strength (UCS) of geopolymer samples, according to certain embodiments.

FIG. 12 illustrates a graph showing the effect of laponite concentration on Young's modulus (YM) of geopolymer cement samples, according to certain embodiments.

FIG. 13 illustrates a graph showing the effect of laponite concentration on Poisson's ratio (PR) of geopolymer cement samples, according to certain embodiments.

FIG. 14 illustrates a graph depicting the influence of temperature on rheological properties including plastic viscosity, yield point, and gel strength of the geopolymer slurry containing 3 wt. % laponite, according to certain embodiments.

### DETAILED DESCRIPTION

In the drawings, reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

Aspects of the present disclosure are directed to a geopolymer cementing composition (also referred to as a composition) that addresses the complex issue of sedimentation in high-pressure well cementing applications. Incorporating laponite particles, in defined weight percentages, into hematite-based fly ash geopolymer slurries mitigates sedimentation problems and ensures homogeneity and density uniformity along cemented sections. The composition of the present disclosure, when used with a defined laponite concentration, provides several advantages over Portland cement, exhibits improved yield point and gel strength, as well as reduced porosity and density variation.

A geopolymer cementing composition, also referred to as a composition, is described. The composition includes a class F fly ash particles (FFA). In some embodiments, the FFA includes class C fly ash and class F fly ash particles. In a preferred embodiment, the FFA is a class F fly ash. In some embodiments, the FFA may be used alone or in combination with other known aluminosilicate source materials. Suitable examples of aluminosilicate source materials include but are not limited to, ground blast furnace slag, calcined clays, partially calcined clays (such as metakaolin), aluminum-containing silica fume, natural aluminosilicate, synthetic aluminosilicate glass powder, zeolite, scoria, allophone, bentonite, and pumice. In some embodiments, a mixture of aluminosilicate sources may be used, with at least one being FFA.

In an embodiment, the FFA includes 50-62.5 wt. % SiO₂, preferably 52 to 60 wt. %, preferably 54 to 58 wt. %, preferably 55 to 57 wt. %, preferably 55 to 56 wt. %, preferably 55.92 wt. %; 25-35 wt. % Al₂O₃, preferably 27 to 33 wt. %, preferably 29 to 31 wt. %, preferably 29.54 wt. %; 2.5-7.5 wt. % CaO, preferably 2.5-7.5 wt. % Fe₂O₃, preferably 3 to 7 wt. %, preferably 3.5 to 6.5 wt. %, preferably 4 to 6 wt. %, preferably 4.5 to 5.4 wt. %, preferably 4.93 wt. %; 0.5-3.5 wt. % TiO₂, preferably 1 to 3 wt. %, preferably 1.2 to 2.8 wt. %, preferably 1.5 to 2.5 wt. %, preferably 1.8 to 2 wt. %, preferably 1.91 wt. %; 0.5-3.5 wt. % K₂O, preferably 0.8 to 3 wt. %, preferably 1 to 2.5 wt. %, preferably 1 to 2 wt. %, preferably 1 to 1.3 to 1.8 wt. %, preferably 1.5 to 1.7 wt. %, preferably 1.66 wt. %, and optionally, 0.1-1.0 wt. % SO₃, each wt. % based on the total weight of the FFA, as determined by X-ray fluorescence (XRF) analysis. In a preferred embodiment, the FFA includes 55.92 wt. % of SiO₂, 29.54 wt. % of Al₂O₃, 5.49 wt. % of CaO, 4.93 wt. % of Fe₂O₃, 1.91 wt. % of TiO₂, 1.66 wt. % of K₂O, 0.39 wt. % of SO₃, 0.04 wt. % of MnO₃, each wt. % based on the total weight of the FFA, as determined by XRF analysis. In some embodiments, the FFA has a specific gravity of about 2 to 4, preferably 2 to 3, preferably 2 to 2.5, preferably 2.2 to 2.4, preferably 2.25.

In some embodiments, the class F fly ash particles have a mean particle size of 5 to 50 μm, preferably 10 to 45 μm, 15 to 40 μm, preferably 19 to 35 μm, preferably 19 to 30 μm, preferably 19 to 25 μm, preferably 19 to 20 μm. In a preferred embodiment, the class F fly ash particles have a mean particle size of 19.35 μm.

In some embodiments, the class F fly ash particles further comprise 0.1 to 1.0 wt. % SO₃, preferably 0.2 to 0.9 wt. % SO₃, preferably 0.3 to 0.8 wt. % SO₃, preferably 0.3 to 0.7 wt. % SO₃, preferably 0.3 to 0.6 wt. % SO₃, preferably 0.3 to 0.5 wt. % SO₃, preferably 0.3 to 0.4 wt. % SO₃. In some embodiments, the class F fly ash particles include about 0.39 wt. % SO₃.

The composition further includes hematite particles, present in an amount of 50 to 100% of the weight of the binder, preferably 55-80 wt. %, preferably 60-80 wt. %, preferably 65 to 80 wt. %, preferably 80 wt. % of the of the weight of the binder. The hematite weighting agent has a specific gravity of 5 to 5.1, preferably 5.05. It can exist in various forms, some of which are kidney ore, a massive, botryoidal (lumpy) or reniform (kidney-shaped) form; specularite, a micaceous (flaky) form; oolitic, a sedimentary form composed of small, rounded grains; red ochre, a red earthy form, and/or combinations thereof. In some embodiments, the hematite particles includes irregularly shaped hematite particles having an average particle size D₅₀ of about 5 to 50 μm, preferably 10 to 45 μm, preferably 20 to 40 μm, preferably 20 to 30 μm, preferably 25 to 30 μm, preferably 26 to 28 μm, preferably 26.24 μm.

The composition further includes laponite particles, present in an amount of 1 to 10% of the weight of the binder, preferably 1 to 5 wt. %, preferably 1 to 3 wt. %. In some embodiments, the composition includes laponite particles which include 52.5 to 65 wt. % SiO₂, preferably 55 to 63 wt. %, preferably 57 to 61 wt. %, preferably 58 to 60 wt. %, preferably 59 to 60 wt. %, preferably 59.5 wt. %; 20 to 35 wt. % MgO, preferably 22 to 33 wt. %, preferably 25 to 30 wt. %, preferably 27 to 29 wt. %, preferably 27 to 28 wt. %, preferably 27.5 wt. %; 1 to 4 wt. % Na₂O, 2 to 3.5 wt. %, preferably 2.5 to 3 wt. %, preferably 2.8 wt. %; and 0.1 to 1.5 wt. % of Li₂O, preferably 0.2 to 1.4 wt. %, preferably 0.5 to 1 wt. %, preferably 0.6 to 0.9 wt. %, preferably 0.7 to 0.8 wt. %, preferably 0.8 wt. %. In a specific embodiment, the composition includes laponite particles 59.5 wt. % of SiO₂, 27.5 wt. % of MgO, 2.8 wt. % Na₂O, and 0.8 wt. % of Li₂O. In some embodiments, the laponite particles have a mean particle size of 1 to 25 μm, preferably 5 to 20 μm, preferably 5 to 15 μm, preferably 5 to 10 μm, preferably 7 to 10 μm. In a specific embodiment, the laponite particles have a mean particle size of about 9.19 μm.

The composition further includes one or more superplasticizers (SPs) in an amount of 2.5 to 10 wt. %, preferably 5-7 wt. %, preferably 5 wt. % of the weight of the binder. The SPs may include one or more sulfonated polymers, one or more carboxylate polymers, and one or more polycarboxylic ethers. In some embodiments, the SPs may also include polycarboxylate ethers, polycarbonate, alkyl citrates, sulfonated naphthalene, sulfonated arene, sulfonated melamine, formaldehyde, and the like. In a preferred embodiment, a polynaphthalene sulfonate (PNS) superplasticizer is used in the composition of the present disclosure.

The composition further includes one or more retarders in an amount of 2.5 to 10 wt. %, preferably 5-7 wt. %, preferably 5 wt. % of the weight of the binder. The retarders include one or more lignosulfonates, one or more hydroxycarboxylic acids, one or more saccharides, one or more cellulose derivatives, and one or more organophosphonates. As used herein, retarders, refer to chemical admixtures that slow the hydration of a cement and may be used in large-scale pours where partial hardening may be unavoidable without the presence of a retarder. Suitable examples of retarders include, without limitation, sugar, sucrose, sodium gluconate, glucose, citric acid, tartaric acid, and the like. In an embodiment, the retarder is a lignosulfonate-based retarder—for example, calcium and sodium lignosulfonate.

The composition further includes one or more defoamer(s) in an amount of 0.01 to 0.02 wt. %, preferably 0.0164 wt. % of the weight of the binder. The defoamer includes one or more of a silicone defoamer, a mineral oil defoamer, an ester defoamer, and an ether defoamer. As used herein, the term, “defoamer” refers to a foam control agent which is added to a system to reduce or eliminate foam or air bubbles after it has been formed. In an embodiment, the defoamer is a dimethyl silicone polymer. In some embodiments, the composition may include an alcohol defoamer, for example, cetostearyl alcohol, lauryl alcohol, cetyl alcohol, stearyl alcohol, oleyl alcohol, decyl alcohol, dodecyl alcohol, and higher fatty alcohols.

The composition further includes a binder including an aqueous alkaline solution comprising 1 to 8 mol/L an alkali activator. The alkali activator includes an alkali metal hydroxide. The alkali metal hydroxide may be one or more of potassium hydroxide, sodium hydroxide, lithium hydroxide, calcium hydroxide, and Na₂SiO₃. In a preferred embodiment, the alkali metal hydroxide is sodium hydroxide. The alkali hydroxide has a concentration in a range of 1-8 M, preferably 2-7 M, preferably 3-6 M, preferably 4-5 M, preferably 4 M.

The composition of the present disclosure has a specific gravity of 15 to 20 ppg, preferably 16 to 19 ppg, preferably 17 to 18 ppg, preferably 17 ppg.

In some embodiments, the composition has a 10 min gel strength of 400 to 650 lbf/100 ft² at 82° F., preferably 500 to 600 lbf/100 ft², preferably 525 to 575 lbf/100 ft², preferably 525 to 550 lbf/100 ft², preferably 525 to 530 lbf/100 ft². In a specific embodiment, the composition has a 10 min gel strength of 528 lbf/100 ft². In some embodiments, the composition has a 10 min gel strength of 75 to 200 lbf/100 ft², preferably 80 to 175 lbf/100 ft², preferably 100 to 150 lbf/100 ft², preferably 110 to 140 lbf/100 ft², preferably 120 to 140 lbf/100 ft², preferably 130 to 140 lbf/100 ft² at 195° F. In a specific embodiment, the composition has a 10 min gel strength of 136 lbf/100 ft² at 195° F. In some embodiments, the composition has a plastic viscosity of 750 to 1250 cP at 82° F., preferably 800 to 1200 cP at 82° F., preferably 850 to 1150 cP at 82° F., preferably 900 to 1100 cP at 82° F., preferably 950 to 1050 cP at 82° F., preferably 1000 to 1050 cP at 82° F., preferably 1010 to 1050 cP at 82° F., preferably 1020 to 1050 cP at 82° F., preferably 1030 to 1050 cP at 82° F., preferably 1040 to 1050 cP at 82° F., preferably 1048 cP at 82° F.; and a plastic viscosity of 250 to 500 cP at 195° F., preferably 275 to 475 cP at 195° F., preferably 300 to 450 cP at 195° F., preferably 325 to 425 cP at 195° F., preferably 350 to 400 cP at 195° F., preferably 350 to 375 cP at 195° F., preferably 359 cP at 195° F. In some embodiments, the composition has a yield point of 10 to 16.5 lbf/100 ft², preferably 11 to 15 lbf/100 ft², preferably 12 to 14 lbf/100 ft², preferably 13 to 14 lbf/100 ft², preferably 13.29 lbf/100 ft² at 82° F., and a yield point of 7.5 to 13.5 lbf/100 ft², preferably 8 to 13 lbf/100 ft², preferably 8.5 to 12.5 lbf/100 ft², preferably 9 to 12 lbf/100 ft², preferably 9.5 to 11.5 lbf/100 ft², preferably 10 to 11 lbf/100 ft², preferably 10.5 to 11 lbf/100 ft², preferably about 10.79 lbf/100 ft² at 195° F.

In some embodiments, the composition is substantially free of an Ordinary Portland Cement.

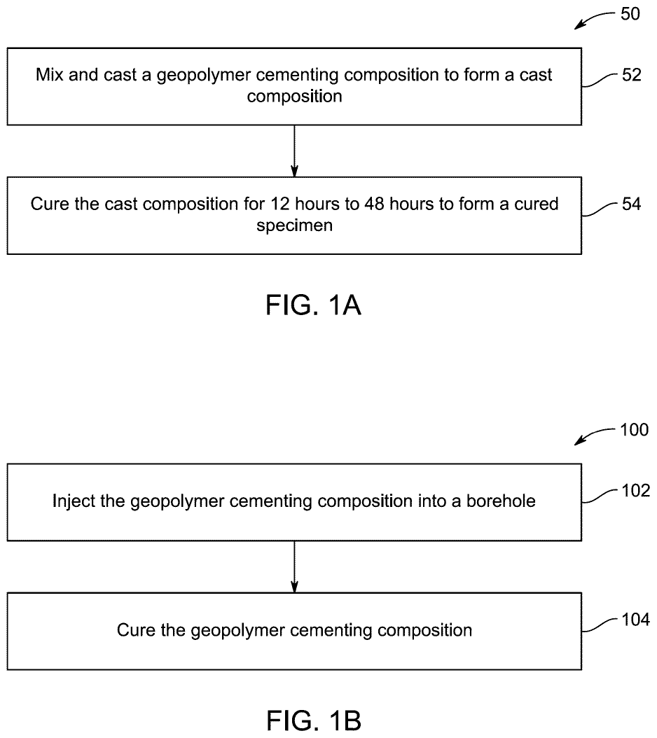

FIG. 1A illustrates a flow chart of a method 50 of producing a cured specimen is described. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes mixing and casting the geopolymer cementing composition to form a cast composition. In this method, the class F fly ash particles, hematite particles, laponite particles, and binder are mixed in defined weight ratios to form a dry mixture of the geopolymer cementing composition. To the dry mix is added an aqueous solution of a base, and mixed at a speed of 10000-15000 rotations per minute (rpm), preferably 11000-13000 rpm, preferably 12000 rpm, for a period of 1-5 minutes, preferably 2-4 minutes, preferably 2 minutes, to form a slurry. In an embodiment, the base may be one or more of potassium hydroxide, sodium hydroxide, lithium hydroxide, and calcium hydroxide. In a preferred embodiment, the base is NaOH.

In alternate embodiments, and a more preferred embodiment, the class F fly ash particles are sieved through a mesh such that the particle size of the class F fly ash particles is less than 200 μm, preferably 190 μm, preferably 170 μm, preferably 150 μm, preferably 130 μm, preferably 120 μm, preferably 110 μm, preferably about 100±5 μm. To this is added the base/alkali activator. In an embodiment, the base may be one or more of potassium hydroxide, sodium hydroxide, lithium hydroxide, and calcium hydroxide. In a preferred embodiment, the base is NaOH. The molar concentration of the base is in the range of 1-5 M, preferably 1-4 M, preferably 2-4 M, preferably 3-4 M, preferably 4 M.

To this is added one or more superplasticizers (SPs), one or more retarders, a defoamer, hematite particles, laponite particles, and binder, in defined weight ratios, to form a slurry of the geopolymer cementing composition. The SPs may include one or more sulfonated polymers, one or more carboxylate polymers, and one or more polycarboxylic ethers; and is present in an amount of 5 to 10% of the weight of the binder. In a preferred embodiment, the SP is polynaphthalene sulfonate (PNS). The retarders include one or more lignosulfonates, one or more hydroxycarboxylic acids, one or more saccharides, one or more cellulose derivatives, and one or more organophosphonates; and is present in an amount of 5 to 10% of the weight of the binder. The defoamer is in an amount of 0.01 to 0.02% of the weight of the binder, preferably about 0.0164%, and includes one or more of a silicone defoamer, a mineral oil defoamer, an ester defoamer, and an ether defoamer.

The slurry was further cast into a mold. As used herein, casting refers to the process in which a fluid material is poured into a mold, which contains a hollow cavity of a desired shape, and then allowed to solidify. The solidified part is ejected, demolded, or broken out of the mold to complete the process. In one embodiment, the wet concrete slurry may be cast into a mold at a temperature of 10-40° C., preferably 15-35° C., more preferably 23-27° C., thereby forming the cast composition.

At step 54, the method 50 includes curing the cast composition for 12 to 48 hours thereby forming the cured specimen. As used herein, the term, “curing” refers to a process during which a chemical reaction (such as polymerization) or physical action (such as evaporation) takes place, resulting in a harder, tougher, or more stable linkage (such as an adhesive bond) or substance (such as concrete). Non-limiting examples of curing processes include water curing, wet covering, formwork curing, membrane curing, sheet curing, absorption heat curing, hot mixing, electrical curing, infrared curing, sand/sawdust covering, or natural curing. The curing is conducted at a temperature of 225 to 375° F., preferably 250 to 350° F. The cured specimen has a 24-hr unconfined compressive strength of 2000 to 3000 psi, a Young's modulus of 3.5 to 9 GPa, and a density of 1.75 to 2.25 g/cm³ by following the scratch test method.

FIG. 1B illustrates a flow chart of a method 100 of downhole cementing is described. Cementing a portion of a wellbore is crucial for providing structural integrity, sealing the annular space, and preventing fluid migration between geological formations. It ensures well stability, minimizes the risk of blowouts, and enables proper zonal isolation during drilling and production operations. In some embodiments, the method of cementing is conducted in at least one of an oil well and a gas well having a temperature of 150 to 400° F. The order in which the method 100 is described is not intended to be construed as a limitation, and any number of the described method steps can be combined in any order to implement the method 100. Additionally, individual steps may be removed or skipped from the method 100 without departing from the spirit and scope of the present disclosure.

At step 102, the method 50 includes injecting into a borehole the geopolymer cementing composition. The injection is performed at a borehole temperature of greater than 150° F., and the geopolymer cementing composition is substantially free of an ordinary Portland Cement.

At step 104, the method 50 includes curing the geopolymer cementing composition. Non-limiting examples of curing processes include water curing, wet covering, formwork curing, membrane curing, sheet curing, absorption heat curing, hot mixing, electrical curing, infrared curing, sand/sawdust covering, or natural curing. The curing is conducted at a temperature of 225 to 375° F., preferably 250 to 350° F.

Once the geopolymer cementing composition is cured, the bottom third of the cured specimen has a density of X and a porosity of Y and the top third of the cured cement has a density of 0.75*X to 1.05*X and a porosity of 0.60*Y to 1.10*Y.

### EXAMPLES

The following examples demonstrate a geopolymer cementing composition, a method of producing a cured specimen, and a method of downhole cementing using the aforesaid geopolymer cementing composition. The examples are provided solely for illustration and are not to be construed as limitations of the present disclosure, as many variations thereof are possible without departing from the spirit and scope of the present disclosure.

### Example 1: Materials

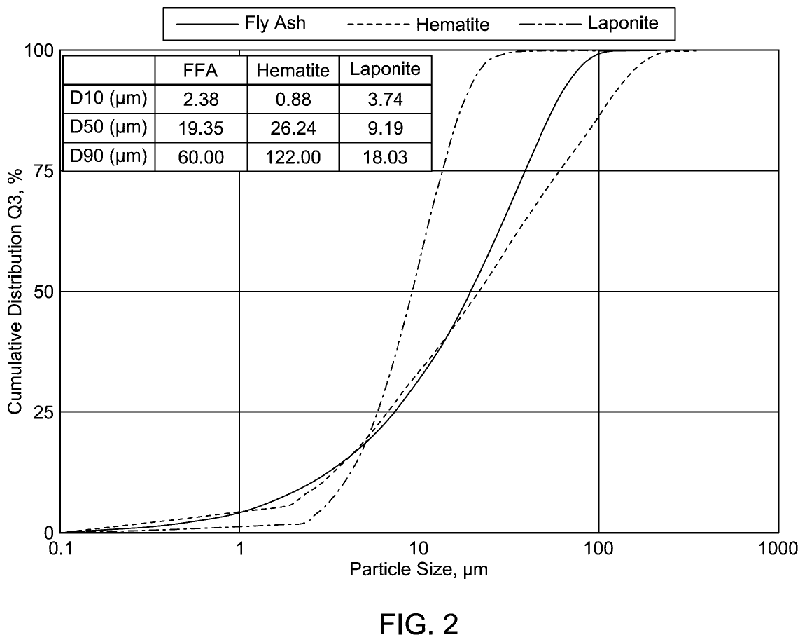

In the present disclosure, various materials are evaluated to determine their suitability for geopolymer applications under wellbore conditions. The aluminosilicate material employed is Class F fly ash (FFA), and the weighting material utilized is hematite. The activator includes a sodium hydroxide (NaOH) solution. Additional chemical additives, including retarders, deformers, and superplasticizers, are incorporated to enhance the performance characteristics of the geopolymer cementing compositions. The specific gravity (SG) of Class F fly ash is measured as 2.25, and the specific gravity of hematite is measured as 5.05. Particle size distribution (PSD) analyses are conducted using a laser diffraction particle size analyser. As shown in FIG. 2, the PSD results indicate that 50% of the particles in Class F fly ash, hematite, and laponite exhibit sizes less than 19.35 μm, 21.54 μm, and 9.19 μm, respectively. X-ray fluorescence (XRF) spectroscopy confirms the high iron oxide (Fe₂O₃) content in the hematite sample, which is measured at approximately 95 wt. %. X-ray diffraction (XRD) analysis further verifies that the hematite material is composed solely of hematite phase. XRF analysis of Class F fly ash indicates significant proportions of silica (SiO₂) and alumina (Al₂O₃), which are essential oxide constituents for effective geopolymerization. The oxide composition determined by XRF analysis is presented in Table 1.

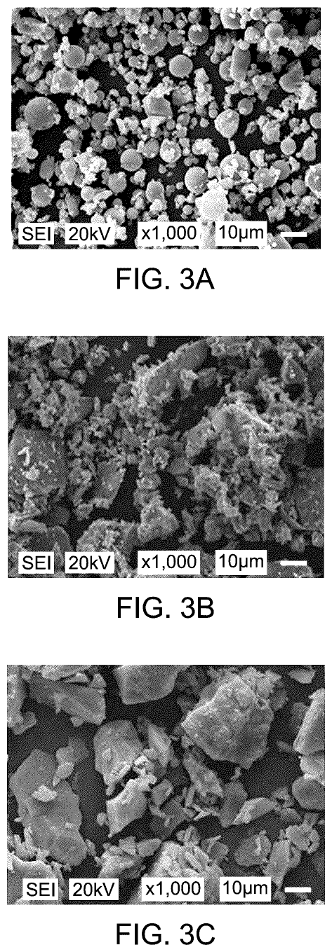

The scanning electron microscopy (SEM) images of FIGS. 3A-3C reveal that the fly ash particles possess predominantly spherical morphology, the hematite particles exhibit irregular shapes, and the laponite particles display a disk-like structure.

TABLE 1
XRF of FFA and laponite in terms of wt. %.

| Oxide | SiO₂ | Al₂O₃ | MgO | CaO | Fe₂O₃ | TiO₂ | K₂O | Na₂O | SO₃ | MnO | Li₂O |
|---|---|---|---|---|---|---|---|---|---|---|---|
| FFA | 55.92 | 29.54 | — | 5.49 | 4.93 | 1.91 | 1.66 | — | 0.39 | 0.04 | — |
| Laponite | 59.50 | — | 27.50 | — | — | — | — | 2.80 | — | — | 0.80 |

### Example 2: Methodology

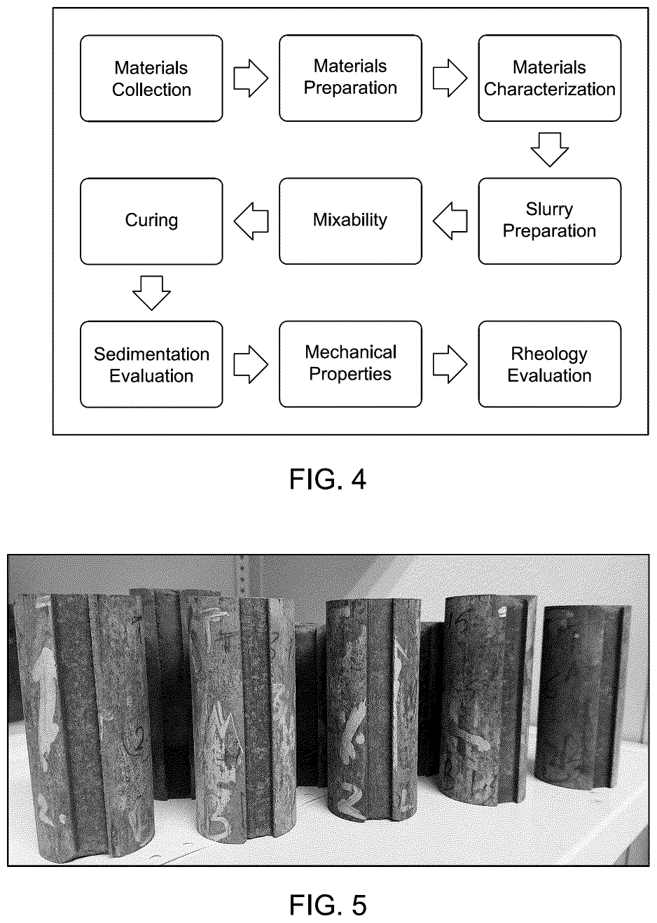

The present disclosure provides an overview of the methodology adopted for evaluating the geopolymer cementing compositions. The experimental process begins with the collection, characterization, and preparation of the required raw materials. Subsequently, slurry formulations are prepared and subjected to mixability assessments to ensure homogeneity and processability. Sedimentation behaviour of the prepared slurries is analysed using three distinct characterization techniques to determine the extent of density variation and solid particle settling within the matrix. Following the sedimentation analysis, the cured geopolymer samples are examined for mechanical and rheological properties to evaluate their performance under wellbore-relevant conditions. A schematic representation is provided in FIG. 4 that outlines the sequence of methods employed in the present disclosure for the preparation, testing, and analysis of the geopolymer cementing compositions.

### Example 3: Materials and Sample Preparation

The specific gravities of the powder-based components utilized in the present disclosure are determined using a gas pycnometer. Class F fly ash (FFA) is subjected to a sieving process to confirm that the particle size remains below 104 μm, which is subsequently verified by particle size distribution (PSD) analysis. To prepare the sodium hydroxide (NaOH) solution, NaOH pellets are dissolved in distilled water using a magnetic stirrer, resulting in a 4 mol/L NaOH solution. The prepared solution is allowed to cool at ambient temperature for a minimum duration of 24 hours prior to commencement of slurry preparation. Among the available techniques for geopolymer slurry preparation, namely the wet and dry mixing processes, the wet process technique is selected for the procedures described in the present disclosure. During the wet mixing procedure, chemical admixtures including superplasticizers and/or retarders are combined with the alkali activation solution and stirred at a high shear rate of 12,000 RPM for a duration of 2 minutes using a high-speed mixer. The dry solid mixture, including the geopolymer precursor and weighting materials, is then added to the pre-mixed solution and further mixed for an additional 2 minutes. Nine formulations of geopolymer slurries are prepared using varying concentrations of laponite, specifically 0, 0.3, 0.6, 0.9, 1.2, 1.5, 2.0, 2.5, and 3.0 wt. % based on the weight of the binder. Laponite concentrations exceeding 3.0 wt. % are observed to yield slurries with excessive viscosity and impaired mixability. The liquid-to-binder ratio is fixed at 0.56. The composition details of the mix design are presented in Table 2.

TABLE 2
The mix design to prepared geopolymer slurries.

| | Wt % relative to weight |
|---|---|
| Component | of the binder, wt % |
| FFA | 100 |
| Hematite | 80 |
| Defoamer | 0.0164 |
| Superplasticizer | 5 |
| Retarder | 5 |
| 4M NaOH | 56 |
| Laponite | 0 to 3 (9 concentrations) |

### Example 4: Sedimentation Evaluation

Sedimentation evaluation in the present disclosure is conducted using three analytical techniques: the American Petroleum Institute (API) method, nuclear magnetic resonance (NMR) analysis, and computed tomography (CT) scanning. Cured geopolymer cement samples are sectioned into three portions: top, middle, and bottom. Each section is individually analysed to evaluate variation in density and structural uniformity along the vertical axis of the sample. Comparative interpretation of results obtained from the API method, NMR analysis, and CT imaging provides detailed insight into sedimentation behaviour and particle distribution throughout the cured cement matrix.

For the API method, each cured geopolymer sample is sectioned into three portions as previously described. The specific gravity of each section is determined using Archimedes' principle by measuring the weight of the section in air and in water using a precision balance. The specific gravity is calculated by dividing the weight in air by the corresponding weight in water. The calculated values are used to generate a density profile for the entire vertical height of the geopolymer sample. Further, NMR analysis is performed to further assess sedimentation within the geopolymer matrix. Cured samples are fabricated into cylindrical shapes and positioned in an NMR apparatus operating under a low magnetic field. NMR measurements are conducted to assess differences in porosity across various sections of the cement sample. Relaxation time data acquired from NMR scans are analysed to quantify sedimentation behaviour and porosity variation along the sample height. CT-scan imaging is employed as a third technique for visual and quantitative assessment of sedimentation. The cured geopolymer samples are scanned using a calibrated medical grade computed tomography (CT) scanner. Cross-sectional images of the internal cement structure are acquired and analysed. The CT scan data is processed to extract sedimentation patterns, evaluate distribution uniformity, and determine settling characteristics of solid particles within the cement matrix.

### Example 5: Mechanical and Rheological Properties

After mixing, the geopolymer slurries are conditioned in an atmospheric consistometer maintained at a temperature of 195° F. and operated at a rotational speed of 150 revolutions per minute (RPM) for a duration of 30 minutes. Rheological evaluations are performed using a rotational viscometer at two target temperatures: 82° F. and 195° F. The evaluation of mechanical properties includes unconfined compressive strength (UCS) measurement and dynamic elastic property determination, specifically Young's modulus (YM) and Poisson's ratio (PR). Following conditioning, each slurry is cast into cylindrical moulds with a diameter of 1.5 inches and a length of 4 inches. The filled moulds are then transferred to a high-pressure high-temperature (HPHT) curing chamber, which is maintained at 292° F. and 3,000 psi for a curing period of 24 hours. UCS is determined using the scratch test method, which involves applying a continuous shearing force by a linear-moving cutter along the longitudinal surface of the cured sample. The applied force generates a corresponding rock strength profile across the length of the specimen. Young's modulus and Poisson's ratio are estimated by measuring the sonic wave velocities through the samples. The required compressional and shear wave velocities are obtained using ultrasonic pulse transmission, from which the elastic properties are calculated.

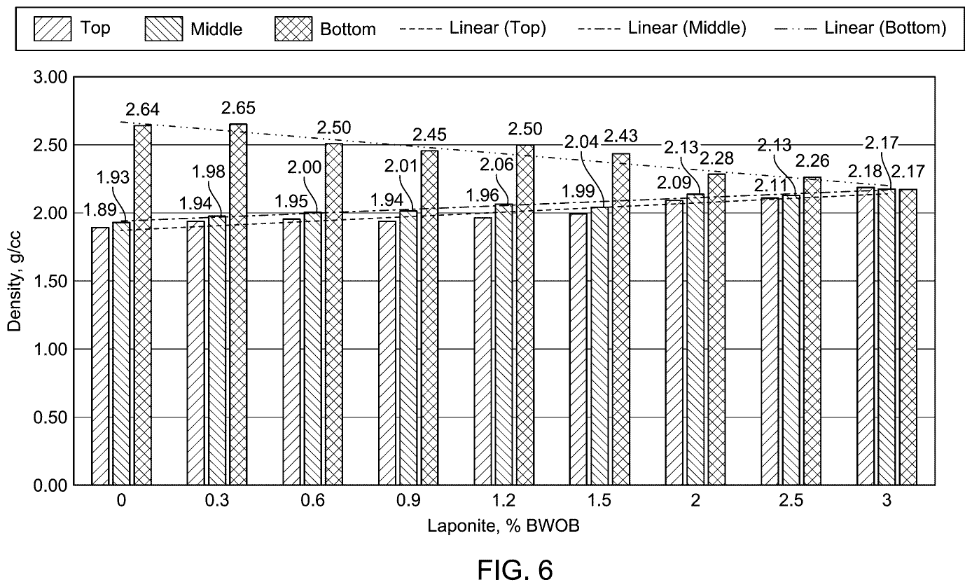

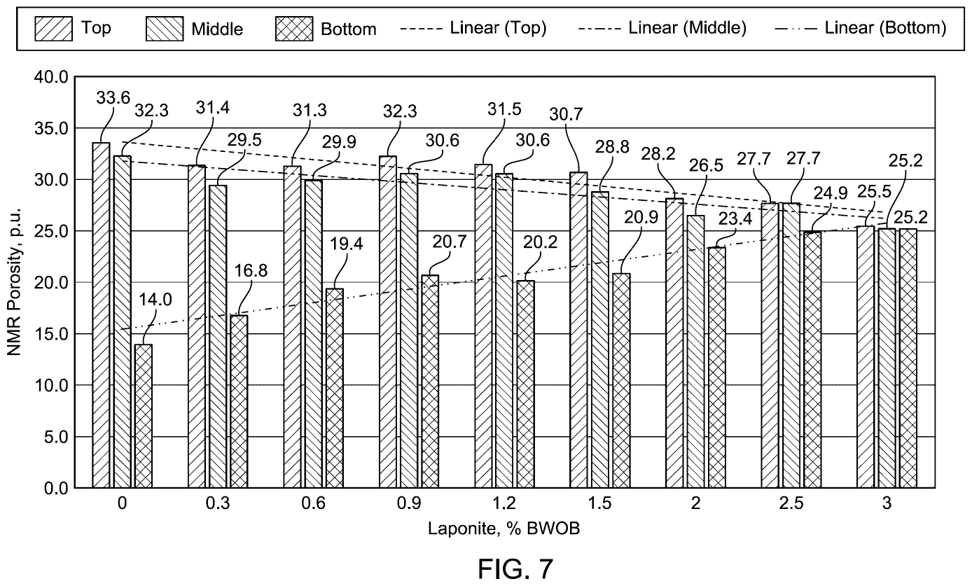

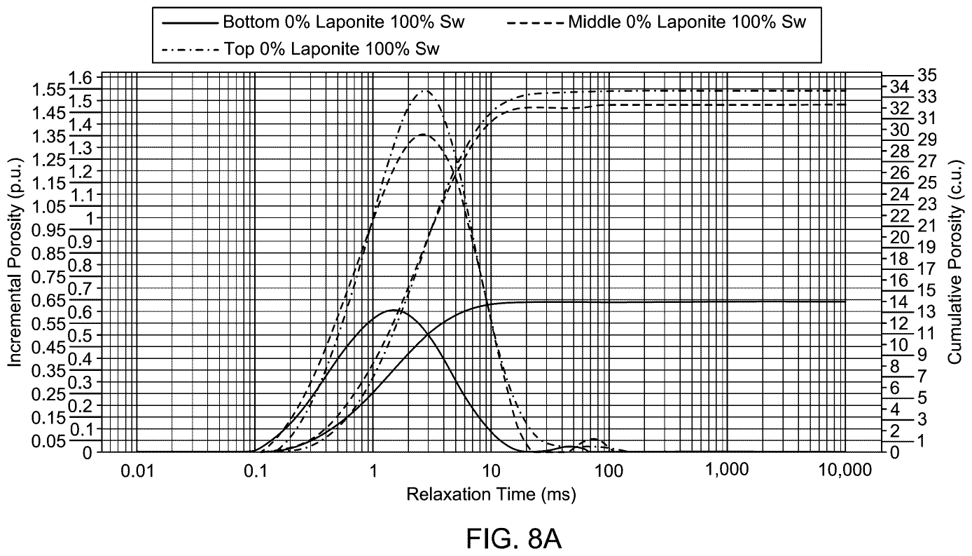

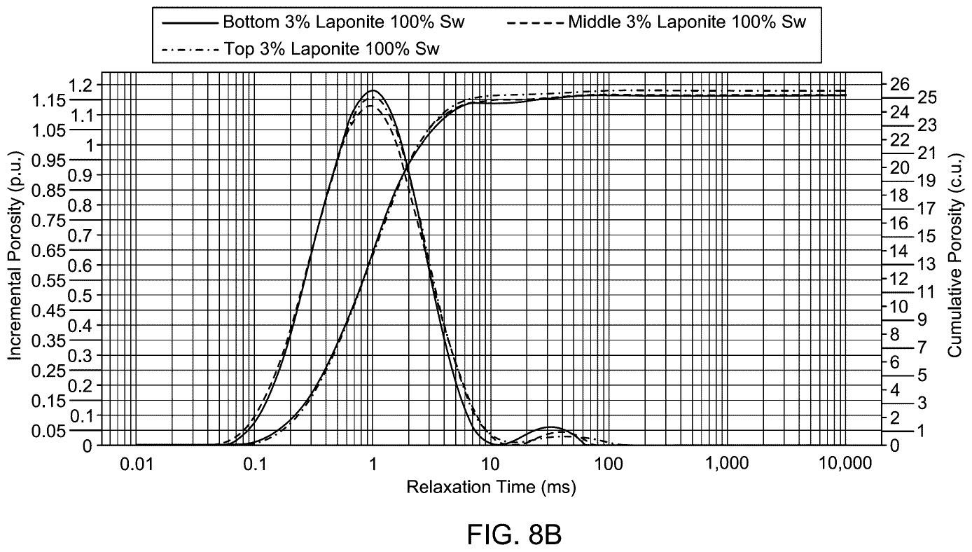

As shown in FIG. 5, cured geopolymer cement samples containing hematite and varying concentrations of laponite are shown. Laponite is incorporated into the high-density geopolymer systems to mitigate challenges associated with sedimentation and stability. A total of nine laponite concentrations, ranging from 0 to 3 wt. % of the weight of the binder, are investigated. Incorporation of 3 wt. % of the weight of the binder laponite results in a reduction of density variation between the top and bottom sections of the geopolymer samples from 39.38% (in the absence of laponite) to 0.58%. As shown in to FIG. 6, the densities of the top, middle, and bottom sections for each laponite concentration, as determined using the API method, are summarized. Nuclear magnetic resonance (NMR) analysis reveals that increasing laponite concentration leads to a progressive decrease in NMR porosity differences among the three sample sections. In FIG. 7, the NMR-derived porosity measurements for each laponite formulation are illustrated. FIGS. 8A-8B show a comparative view of NMR porosity is provided for laponite concentrations of 0 wt. % and 3 wt. % of the weight of the binder. At 0 wt. % of the weight of the binder, significant porosity variation is observed between the top and bottom sections, whereas at 3 wt. % of the weight of the binder, the porosity values across sections are nearly uniform.

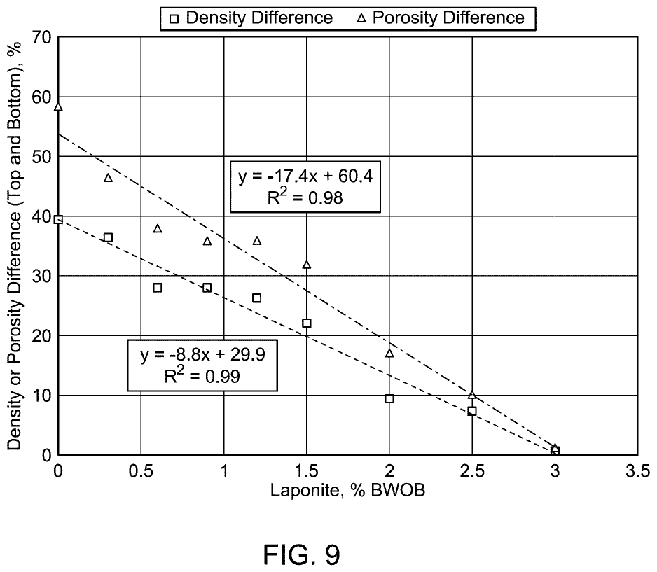

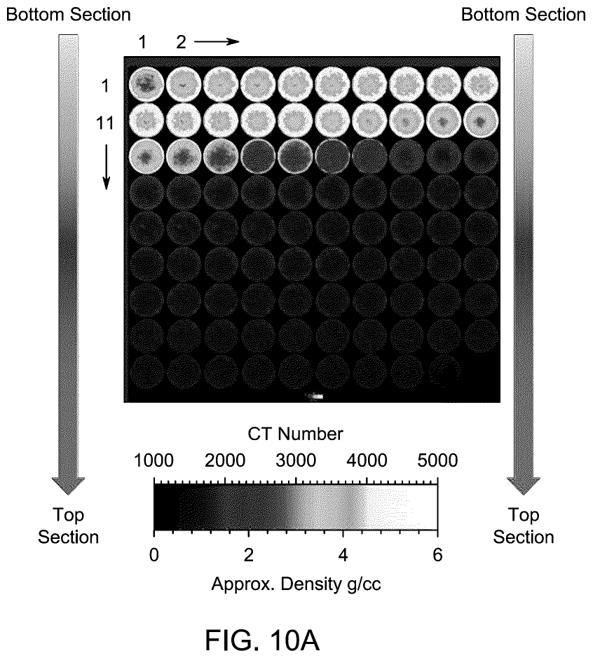

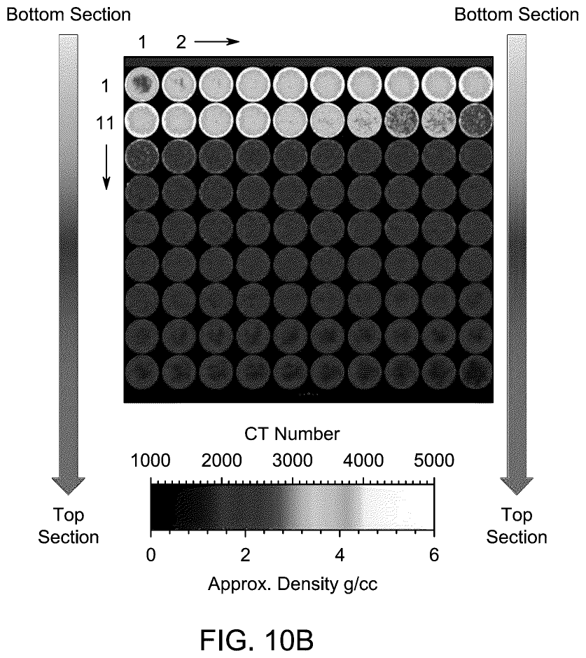

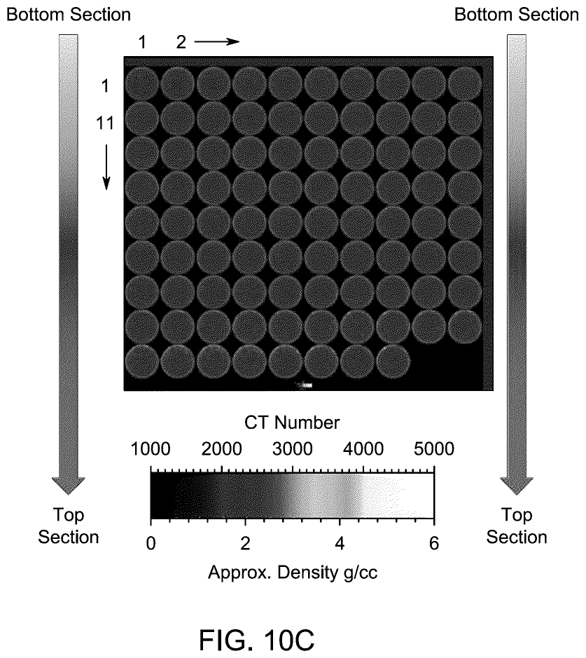

As shown in FIG. 9, an overview of the correlation between laponite concentration and the corresponding differences in density and NMR porosity is presented. The coefficient of determination (R²) is calculated as 0.99 for density variation and 0.98 for NMR porosity variation, indicating strong correlation. Furthermore, CT-scan imaging results in FIGS. 10A-10C are shown to further validate the findings from the API and NMR methods. FIG. 10A illustrates a sample prepared without laponite, where significant density variations are visible across different cross-sections. In contrast, FIG. 10B and FIG. 10C, corresponding to intermediate and 3 wt. % of the weight of the binder laponite concentrations respectively, exhibit progressively reduced density differences, with FIG. 10C demonstrating uniform colour across the slices, indicating minimal density variation within the same sample.

Based on the consolidated outcomes of API, NMR, and CT-scan techniques, the optimal concentration of laponite is determined to be 3 wt. % of the weight of the binder. The effectiveness of laponite in reducing sedimentation and enhancing system stability is attributed to multiple physicochemical properties. Laponite consists of plate-like particles possessing negatively charged surfaces. Upon dispersion in an aqueous medium, the particles experience mutual electrostatic repulsion, resulting in a stable colloidal suspension where the particles remain uniformly dispersed. Laponite also demonstrates gel-forming capability, where a three-dimensional network structure entraps water and suspended particles, reducing settling behaviour. The thixotropic nature of laponite contributes further to suspension stability. Under shear, the viscosity of the system decreases, enabling flow and mixing; upon cessation of shear, the viscosity rapidly increases, which immobilizes suspended particles and minimizes sedimentation. The flat morphology and high surface area-to-volume ratio of laponite particles enhance interaction with the surrounding matrix, thereby impeding gravitational settling. These combined characteristics render laponite an effective anti-sedimentation additive in high-density geopolymer systems. Following the verification of laponite's effectiveness in addressing sedimentation and stability issues in geopolymer cementing compositions, the influence of laponite on additional mechanical properties is evaluated.

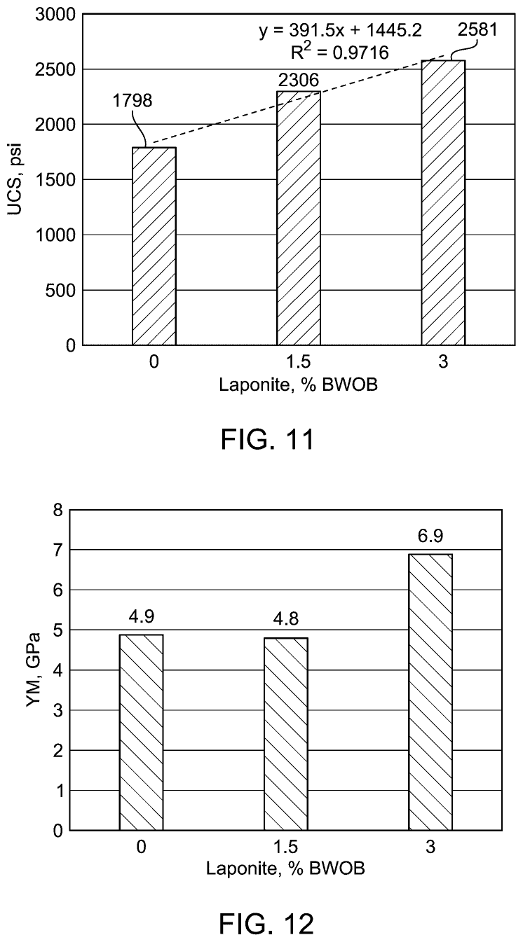

As shown in FIG. 11, the unconfined compressive strength (UCS) of geopolymer cement samples after 24 hours of curing is shown for varying laponite concentrations. The incorporation of the optimum laponite concentration results in a 43.54% increase in 24-hour UCS as compared to the sample without laponite. A linear increase in UCS values is observed with increasing laponite concentration, with a coefficient of determination (R²) of 0.97. Field operations often rely on a minimum compressive strength threshold of approximately 500 psi prior to drilling through the casing shoe. The geopolymer cement systems developed in the present disclosure consistently demonstrate 24-hour UCS values exceeding 1,798 psi. The aforementioned values not only surpass the minimum requirements commonly cited in the literature but also exceed the UCS performance metrics of reported heavy weight cementing systems. As shown in FIG. 12, Young's modulus (YM) of the geopolymer cement samples increases from 4.9 GPa to 6.9 GPa with increasing laponite concentration from 0 wt. % to 3 wt. % of the weight of the binder.

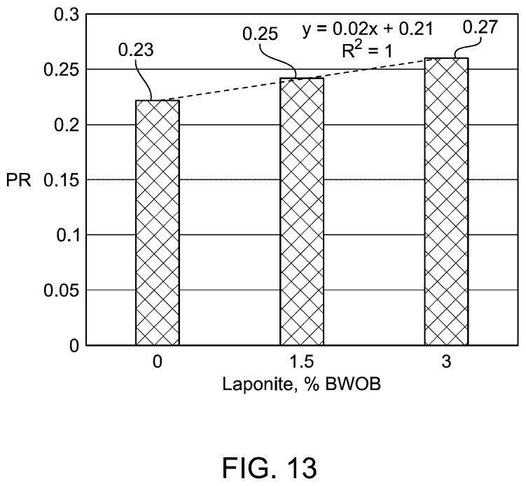

Although an upward trend in YM is observed, the values remain lower than those associated with conventional Class G cement. As shown in FIG. 13, laponite incorporation also yields a positive linear effect on Poisson's ratio (PR), with PR increasing from 0.23 to 0.27 across the same concentration range. The linear correlation between laponite content and PR is confirmed by a coefficient of determination (R²) of 1.00.

Cement systems with reduced Young's modulus are preferred for cementing operations in unconsolidated formations due to improved accommodation of mechanical stresses under strain. The developed geopolymer systems demonstrate YM values within the range of 4.8 GPa to 6.9 GPa and PR values ranging from 0.23 to 0.27, as illustrated in FIG. 12 and FIG. 13. Compared to Class G cement, the geopolymer systems of the present disclosure exhibit enhanced flexibility.

As reported previously, a lower Young's modulus in comparison to shale or consolidated formations provides an advantage in terms of mechanical compatibility. The developed geopolymer systems meet this criterion, indicating suitability for placement adjacent to shale or other consolidated formations. The combination of moderate UCS, reduced Young's modulus, and improved Poisson's ratio indicates that the developed geopolymer cement systems are well-suited to withstand dynamic wellbore stress environments. Cement systems with reduced YM, adequate UCS, and enhanced tensile resilience are capable of simulating and absorbing wellbore stress conditions more effectively, resulting in improved integrity and long-term performance of zonal isolation.

Rheological characterization of cement slurries is essential due to its impact on mixing, pumpability, and effective displacement of drilling mud within the wellbore. The rheological behaviour of the geopolymer slurry containing 3 wt. % laponite is evaluated at two representative temperatures corresponding to surface and downhole conditions, specifically 82° F. and 195° F., respectively. Rheological analysis indicates that the Bingham Plastic model provides the best fit for the flow behaviour of the geopolymer cementing composition. The Bingham model parameters at 82° F. and 195° F. are presented in Tables 3 and 4.

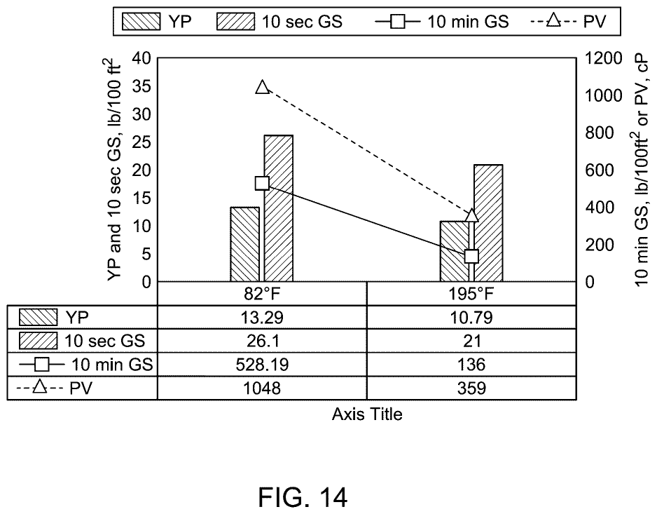

The addition of laponite increases the yield point (YP) of the slurry by 48.32% at 82° F. and by 46.4% at 195° F. However, an increase in laponite concentration is also associated with a corresponding increase in plastic viscosity (PV), with PV values increasing by 56.65% and 24.17% at 82° F. and 195° F., respectively. Gel strength (GS) is a critical parameter in determining the ability of the slurry to suspend and transport solid particles under static conditions. Additionally, gel strength development over time is important in preventing gas migration into the cement column. As shown in FIG. 14, the influence of temperature on the rheological properties of the geopolymer slurry containing 3 wt. % laponite is illustrated. An increase in temperature from 82° F. to 195° F. results in a significant decrease in plastic viscosity by 65.74%, indicating improved flow characteristics at elevated temperatures. The values for yield point and 10-second gel strength remain relatively stable across both temperatures. However, the 10-minute gel strength exhibits a substantial reduction of 74.25% with increasing temperature.

The aforementioned rheological observations are relevant for field deployment of geopolymer cement systems, particularly in high-temperature and high-pressure well environments, where maintaining suspension stability and preventing gas influx are critical to long-term cementing success.

TABLE 3
The effect of laponite on the rheological
parameters at surface temperature (82° F.).

| Parameter | 0% Laponite | 3% Laponite |
|---|---|---|
| YP | 8.96 | 13.29 |
| PV | 669 | 1048 |

TABLE 4
The effect of laponite on the rheological parameters
at downhole temperature (195° F.).

| Parameter | 0% Laponite | 3% Laponite |
|---|---|---|
| YP | 7.37 | 10.79 |
| PV | 289.1 | 359 |

The aspects of the present disclosure demonstrate the technical advancement achieved through the incorporation of laponite into hematite-based geopolymer cementing compositions. The research findings confirm that the optimal concentration of laponite is 3 wt. % of the weight of the binder, effectively mitigating sedimentation issues and enhancing structural uniformity across the vertical profile of cured cement samples. The addition of laponite contributes to a significant improvement in compressive strength, with values exceeding field-recommended minimum thresholds, thereby supporting the suitability of the compositions for primary cementing operations in high-pressure wells. Despite the enhancement in mechanical strength, the Young's modulus remains lower than that of Class G cement, indicating improved flexibility and compatibility for use in unconsolidated formations and in zones adjacent to shale or consolidated rock strata. The increase in Poisson's ratio with laponite addition further supports this flexible performance profile. The rheological properties of the geopolymer slurries are also influenced by laponite incorporation, with marked improvements in yield point (YP) and gel strength (GS), both of which are essential for effective suspension stability and gas migration resistance. Temperature-dependent behaviour further indicates a favourable reduction in plastic viscosity (PV) at elevated temperatures, while YP and GS remain stable, indicating dependable rheological behaviour across varying wellbore conditions. The present disclosure enables application of the developed geopolymer systems in various oil and gas well scenarios, including deep and high-temperature wells, formations with poor structural integrity, and zones requiring enhanced flexibility to accommodate subsurface stress regimes. Additional use cases include cementing across lost circulation zones, environmentally sensitive drilling operations requiring reduced carbon footprints, and high-pressure reservoir completions where density control and mechanical integrity are critical. The combined benefits of improved density homogeneity, enhanced strength, controlled flexibility, and sedimentation resistance establish the disclosed geopolymer-laponite systems as a technically robust and field-ready alternative to conventional cement systems.

Numerous modifications and variations of the present disclosure are possible in light of the above teachings. It is therefore to be understood that within the scope of the appended claims, the invention may be practiced otherwise than as specifically described herein.

1. A method of downhole cementing, the method comprising injecting a geopolymer cementing composition into a borehole in a subterranean geologic formation; and
curing the geopolymer cementing composition,
wherein the injecting is performed at a borehole temperature of greater than 150° F., and
wherein the geopolymer cementing composition comprises class F fly ash particles, hematite particles, laponite particles and a binder,
wherein the wherein the class F fly ash particles comprise:
50 to 62.5 wt. % SiO₂,
25 to 35 wt. % Al₂O₃,
2.5 to 7.5 wt. % CaO,
2.5 to 7.5 wt. % Fe₂O₃,
0.5 to 3.5 wt. % TiO₂, and
0.5 to 3.5 wt. % K₂O;
wherein the laponite particles comprise:
52.5 to 65 wt. % SiO₂,
20 to 35 wt. % MgO,
1 to 4 wt. % Na₂O, and
0.1 to 1.5 wt. % Li₂O,
wherein the binder comprises an aqueous alkaline solution, the aqueous alkaline solution comprising 1 to 8 mol/L of an alkali activator,
wherein the alkali activator is one or more selected from the group consisting of KOH, NaOH, and Na₂SiO₃,
wherein the bottom third of the cured cement has a density of X and a porosity of Y and the top third of the cured cement has a density of 0.75*X to 1.05*X and a porosity of 0.60*Y to 1.10*Y.

2. The method of claim 1, wherein the class F fly ash particles have a mean particle size of 5 to 100 μm.

3. The method of claim 1, wherein the class F fly ash particles further comprise 0.1 to 1.0 wt. % SO₃.

4. The method of claim 1, wherein the hematite particles have a mean particle size of 5 to 50 μm.

5. The method of claim 1, wherein the laponite particles have a mean particle size of 1 to 25 μm.

6. The method of claim 1, wherein the alkali activator is NaOH.

7. The method of claim 1, wherein the laponite particles are present in an amount of 0.1 to 10% of the weight of the binder.

8. The method of claim 1, wherein the hematite particles are present in an amount of 50 to 90% of the weight of the binder.

9. The method of claim 1, wherein the geopolymer cementing composition further comprises:
one or more superplasticizers (SPs) in an amount of 2.5 to 10% of the weight of the binder;
one or more retarders in an amount of 2.5 to 10% of the weight of the binder; and
a defoamer in an amount of 0.01 to 0.02% of the weight of the binder.

10. The method of claim 1, the geopolymer cementing composition having
a 10 min gel strength of 400 to 650 lbf/100 ft² at 82° F.; and
a 10 min gel strength of 75 to 200 lbf/100 ft² at 195° F.

11. The method of claim 1, the geopolymer cementing composition having
a plastic viscosity of 750 to 1250 cP at 82° F.; and
a plastic viscosity of 250 to 500 cP at 195° F.

12. The method of claim 1, the geopolymer cementing composition having
a yield point of 10 to 16.5 lbf/100 ft² at 82° F.; and
a yield point of 7.5 to 13.5 lbf/100 ft² at 195° F.

13. The method of claim 1, wherein the geopolymer cementing composition is substantially free of an Ordinary Portland Cement.

14. The method of claim 1, wherein the cured cement has a 24-hr unconfined compressive strength of 2000 to 3000 psi.

15. The method of claim 1, wherein the cured cement has a Young's modulus of 3.5 to 9 GPa.

16. The method of claim 1, wherein the cured cement has a density of 1.75 to 2.25 g/cm³.

17. The method of claim 1, wherein the method of downhole cementing is conducted in at least one of an oil well and a gas well having a temperature of 150 to 400° F.
